(19) United States
(12) Patent Application Publication
(10) Pub. No.: US 2026/0196545 A1
(43) Pub. Date: Jul. 9, 2026

(54) PROTON EXCHANGE MEMBRANE BASED ON PVDF IN THE FORM OF CRYOCRUSHED GRANULES

(71) Applicant: Arkema France, Puteaux (FR)

(72) Inventors: Samuel DEVISME, Colombes (FR); Helene MEHEUST, Serquigny (FR); Anthony BONNET, Colombes (FR); Mauranne VASSY, Serquigny (FR)

(21) Appl. No.: 19/133,300

(22) PCT Filed: Nov. 28, 2023
(86) PCT No.: PCT/FR2023/051865

§ 371 Date: May 28, 2025

(30) Foreign Application Priority Data
Nov. 29, 2022 (FR) 2212492

(51) Int. Cl. H01M 8/1039; C08F 8/38; C08J 3/28; C08J 5/22; H01M 8/10

(52) U.S. Cl. CPC H01M 8/1039; C08F 8/38; C08J 3/28; C08J 5/225; C08F 2800/20; C08F 2810/00; C08J 2351/06; H01M 2008/1095; H01M 2300/0082

(57) ABSTRACT

The present invention relates to a proton exchange membrane, to the process for preparing said membrane, and to the application of said membrane in fields requiring ion exchange, such as effluent purification and electrochemistry, or in energy fields. In particular, this membrane is used in the design of fuel cell membranes.

### FIELD OF THE INVENTION

The present invention relates to a proton exchange membrane based on PVDF in the form of cryogenically ground granules, to the process for preparing said membrane, and to the application of said membrane in fields requiring ion exchange, such as electrochemistry or in energy fields. In particular, this membrane is used in the design of fuel cell membranes, such as proton-conducting membranes for H₂/air or H₂/O₂ fuel cells (these cells being known by the abbreviation PEMFC for “Proton Exchange Membrane Fuel Cell”) or methanol/air fuel cells (these cells being known by the abbreviation DMFC for “Direct Methanol Fuel Cell”).

### TECHNICAL BACKGROUND

A fuel cell is an electrochemical generator which converts the chemical energy of a fuel oxidation reaction in the presence of an oxidant to electrical energy, heat and water. In general, a fuel cell comprises a plurality of electrochemical cells mounted in series, each cell comprising two electrodes of opposite polarity separated by a proton exchange membrane acting as a solid electrolyte. The membrane allows the protons formed during the oxidation of the fuel at the anode to pass to the cathode.

The membranes structure the core of the fuel cell and they must consequently have good proton conduction performance and also low permeability to the reactive gases (H₂/air or H₂/O₂ for PEMFC cells and methanol/air for DMFC cells). The properties of the materials constituting the membranes are essentially thermal stability, resistance to hydrolysis and oxidation, and a degree of mechanical flexibility.

Membranes commonly used that meet these requirements are membranes obtained from polymers belonging, for example, to the family of polysulfones, polyetherketones, polyphenylenes and polybenzimidazoles. However, it has been found that these nonfluorinated polymers degrade relatively rapidly in a fuel cell environment, and their service life remains, for the time being, insufficient for the PEMFC application.

Most proton exchange membranes are based on the chemistry of perfluorinated polymers possessing long or short branches bearing a sulfonate function. In addition to their high cost, these various polymers have a low resistance to hydroxyl radicals, which limits their durability in a fuel cell environment, and they have a low mechanical strength. These membranes furthermore have an ionic conductivity/hydrogen permeability ratio that does not make it possible to obtain thin membranes that combine high impermeability and high conductivity. Moreover, perfluorinated membranes have a temperature use limit that does not allow them to operate at temperatures above 80° C. for long periods of time.

In order to obtain long-term efficiency in terms of proton conduction at temperatures above 80° C., some authors have proposed more complex materials comprising, in addition to a polymer matrix, proton-conducting particles, the conductivity thus no longer being attributed solely to the polymer(s) constituting the membranes. This is the case for application WO 2014/173885, which describes composite materials comprising a polymer matrix and a filler consisting of inorganic ion exchange particles, said particles being synthesized in situ within the fluorinated polymer matrix. These membranes exhibit a more homogeneous distribution of the inorganic particles within the polymer matrix. However, this type of membrane has poorer mechanical properties than a membrane made of polymer matrix alone, a risk of cavitation at the particle-matrix interface due to variations in dimensions during the operation of the fuel cell, and is difficult to produce on an industrial scale.

Ion-conducting membranes produced by radiation-induced grafting are another option for improving their chemical stability. The radiation-induced grafting reaction is controlled by the diffusion of the monomers in the film and the monomer polymerization reactions. The reaction starts at the surface of the irradiated film and gradually moves through the bulk of the film. Films based on ethylene-tetrafluoroethylene (ETFE), fluorinated ethylene-propylene (FEP) and ethylene-chlorotrifluoroethylene (ECTFE) have been described, in particular for amphoteric ion exchange membranes.

The application PCT/FR2022/051032 describes a material consisting of an irradiated PVDF, in powder form, formed of particles having a volume-mean diameter (Dv50) ranging from 10 to 50 μm, onto which are grafted a styrene monomer and a nitrile monomer, said irradiated and grafted PVDF bearing proton exchange sulfonate groups. In this document, said powder is obtained by emulsion polymerization, leading to the production of a latex of particles of approximately 200 nm which, after drying, for example spray drying, results in particles having a tapped bulk density of strictly less than 0.4 g/ml.

There is a real need for proton exchange membranes that have improved properties, in particular improved thermal resistance and a higher conductivity/gas permeability ratio.

### SUMMARY OF THE INVENTION

To overcome the abovementioned disadvantages, the inventors have developed a membrane that has a very particular morphology obtained starting from a polymer based on vinylidene fluoride (PVDF) in the form of irradiated PVDF powder, said powder resulting from the grinding of granules.

According to a first aspect, the invention relates to a material consisting of an irradiated PVDF in powder form to which at least one vinyl monomer is grafted, said irradiated and grafted PVDF bearing proton exchange sulfonate groups.

Characteristically, the tapped bulk density of said powder is greater than 0.4 g/ml.

This PVDF powder results from the grinding of granules having a particle size with a D50 of between 30 and 80 μm.

Said PVDF is chosen from poly(vinylidene fluoride) homopolymers and copolymers of vinylidene difluoride with at least one comonomer chosen from the list: vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoro (propyl vinyl ether), perfluoro(methyl vinyl ether), bromotrifluoroethylene, chlorofluoroethylene, chlorotrifluoroethylene, chlorotrifluoropropene, ethylene and mixtures thereof.

According to a second aspect, the invention relates to a process for preparing said material, said process comprising the grafting of an irradiated PVDF powder with at least one vinyl monomer chosen from styrene monomers and nitrile monomers, or with a mixture of styrene and nitrile monomers, followed by a post-treatment of the PVDF powder thus irradiated and grafted, by sulfonation.

According to a third aspect, the invention relates to a proton exchange polymer electrolyte membrane, said membrane consisting of a film obtained from said PVDF material.

According to a fourth aspect, the invention relates to a process for producing the proton exchange polymer electrolyte membrane from said irradiated, grafted and functionalized PVDF material in powder form, said process comprising converting the PVDF powder into film form.

According to another aspect, the invention relates to a proton exchange polymer composite membrane, said membrane consisting of a porous polymer support impregnated with said PVDF material by the solvent and/or aqueous route.

According to another aspect, the invention relates to a proton exchange polymer composite membrane, said membrane consisting at least partly of fibers of said PVDF material, the remainder being a polymer, and being produced by electrospinning. This membrane is then impregnated with said PVDF material by the solvent or aqueous route.

According to another aspect, the invention relates to the applications of the proton exchange polymer electrolyte membrane in the following fields:
fuel cells, for example H₂/air or H₂/O₂ fuel cells or methanol/air fuel cells;
electrolyzers;
lithium batteries, it being possible for said membranes to be part of the composition of the electrolytes.

The present invention makes it possible to overcome the disadvantages of the prior art. More particularly, it provides a technology that makes it possible to:
improve the thermal resistance of the film with no flow for a temperature below 120° C.;
improve the resistance to hydroxyl radicals compared to commercial NAFION-type membranes;
improve the conductivity/hydrogen permeability ratio compared to the prior art.

Surprisingly, the use of a dense powder obtained from ground particles of between 30 and 120 μm, having a tapped bulk density of greater than 0.4 g/ml, promotes the diffusion of the monomers within the powder and thus leads to degrees of grafting of between 10% and 100%. The use of a powder in which the particles have a tapped bulk density of greater than 0.4 g/ml also makes it possible to have a better grafting yield, namely of greater than 0.8, compared to the post-synthesis powder which has a tapped bulk density of less than 0.4 g/ml. The grafting yield is defined as the ratio of the mass of product obtained after grafting to the mass of product that should be obtained in theory.

The powder can then be sulfonated so that it contains proton exchange groups, making it possible to obtain an ion exchange capacity (IEC) of greater than 0.65 mmol/g. It is also possible to use it as binder or membrane, after conversion, or even in both forms, for the production of a membrane-electrode assembly, with very high compatibility between the binder and the membrane and therefore improved efficiency.

Using a sulfonated grafted powder also makes it possible to adjust the morphology of the membrane using the conventional techniques for converting powder to film of those skilled in the art. This makes it possible to obtain a high degree of variability in the properties, in particular the proton conductivity/hydrogen permeability ratios, tailored to the requirements of the application in question.

### BRIEF DESCRIPTION OF THE FIGURES

FIG. 1 is a scanning electron micrograph of a powder of PVDF homopolymer according to the invention, having a D50 of 50 μm and a tapped bulk density of 0.88 g/ml.

FIG. 2 is a scanning electron micrograph of a powder of PVDF homopolymer having a D50 of 10 μm and a tapped bulk density of 0.26 g/ml.

### DESCRIPTION OF EMBODIMENTS OF THE INVENTION

The invention will now be described in greater detail and non-limitingly in the description that follows.

According to a first aspect, the invention relates to a material consisting of an irradiated PVDF in powder form to which at least one vinyl monomer is grafted, said irradiated and grafted PVDF bearing proton exchange sulfonate groups, characterized in that the tapped bulk density of said powder is greater than 0.4 g/ml.

According to another aspect, the invention relates to a proton exchange polymer electrolyte membrane, said membrane being obtained from said PVDF material.

According to various embodiments, said material and said membrane comprise the following features, combined where appropriate. The contents indicated are expressed by weight, unless otherwise mentioned.

### PVDF

The fluoropolymer used in the invention and generically denoted by the abbreviation PVDF is a polymer based on vinylidene difluoride.

According to one embodiment, the PVDF is a poly(vinylidene fluoride) homopolymer or a mixture of vinylidene fluoride homopolymers. The term “VDF homopolymer” includes PVDF homopolymers comprising up to 1% by weight of a comonomer from those mentioned below.

According to one embodiment, the PVDF is a poly(vinylidene fluoride) homopolymer or a copolymer of vinylidene difluoride with at least one comonomer compatible with vinylidene difluoride.

The comonomers compatible with vinylidene difluoride can be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF═CF₂, Rf being an alkyl group, preferably a C₁ to C₄ alkyl group (preferred examples being perfluoro (propyl vinyl ether) and perfluoro(methyl vinyl ether)).

The fluorinated comonomer may include a chlorine or bromine atom. It may in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

The fluoropolymer preferably contains at least 50 mol % of vinylidene difluoride.

According to one embodiment, the PVDF is a copolymer of vinylidene fluoride (VDF) and of hexafluoropropylene (HFP) (P(VDF-HFP)), having a weight percentage of hexafluoropropylene monomer units of from 1% to 35%, preferably from 2% to 23%, preferably from 4% to 20%, by weight, relative to the weight of the copolymer.

According to one embodiment, the PVDF is a mixture of a poly(vinylidene fluoride) homopolymer and of a VDF-HFP copolymer.

According to one embodiment, the vinylidene fluoride copolymer of the invention is a melt-convertible heterogeneous thermoplastic copolymer, and comprises two or more co-continuous phases, said co-continuous phases comprising:
a) from 25% to 50% by weight of a first co-continuous phase comprising 90% to 100% by weight of vinylidene fluoride monomer units and 0% to 10% by weight of units of at least one other fluorinated monomer, and
b) from more than 50% by weight to 75% by weight of a second co-continuous phase comprising from 65% to 95% by weight of vinylidene fluoride monomer units and one or more comonomers chosen from the group consisting of hexafluoropropylene and perfluoro (vinyl ether), to bring about the phase separation of the second co-continuous phase from the first co-continuous phase.

Said heterogeneous copolymer contains two or more phases that produce a co-continuous structure in the solid state. The co-continuous phases are distinct from each other and can be observed with a scanning electron microscope (SEM). The heterogeneous copolymers according to the invention differ from homogeneous copolymers, which comprise a single phase.

According to one embodiment, the PVDF is a mixture of two or more VDF-HFP copolymers.

According to one embodiment, the PVDF comprises monomer units bearing at least one of the following functions: carboxylic acid, carboxylic acid anhydride, carboxylic acid esters, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluorinated monomer with a monomer bearing at least one of said functional groups and a vinyl function capable of copolymerizing with the fluorinated monomer, according to techniques well known to those skilled in the art.

According to one embodiment, the functional group bears a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units bearing the carboxylic acid function also comprise a heteroatom chosen from oxygen, sulfur, nitrogen and phosphorus.

According to one embodiment, the functionality is introduced via the transfer agent used during the synthesis process. The transfer agent is a polymer which has a molar mass of less than or equal to 20 000 g/mol and which bears functional groups chosen from the following groups: carboxylic acid, carboxylic acid anhydride, carboxylic acid ester, epoxy groups (such as glycidyl), amide, hydroxyl, carbonyl, mercapto, sulfide, oxazoline, phenolic, ester, ether, siloxane, sulfonic, sulfuric, phosphoric or phosphonic. An example of a transfer agent of this type is oligomers of acrylic acid.

The content of functional groups in the PVDF is at least 0.01 mol %, preferably at least 0.1 mol %, and at most 15 mol %, preferably at most 10 mol %.

The PVDF preferably has a high molecular weight. The term “high molecular weight”, as used here, means a PVDF having a melt viscosity of greater than 100 Pa·s, preferably of greater than 500 Pa·s, more preferably of greater than 1000 Pa·s, advantageously of greater than 2000 Pa·s. The viscosity is measured at 232° C., at a shear gradient of 100 s⁻¹, using a capillary rheometer or a parallel-plate rheometer, according to the standard ASTM D3825. The two methods give similar results.

The PVDF homopolymers and the VDF copolymers used in the invention can be obtained by known polymerization methods, such as emulsion polymerization.

According to one embodiment, they are prepared by an emulsion polymerization process in the absence of a fluorinated surfactant.

The polymerization of the PVDF results in a latex generally having a solids content of from 10% to 60% by weight, preferably from 10% to 50%, and having a weight-average particle size of less than 1 micrometer, preferably of less than 1000 nm, preferably of less than 800 nm and more preferably of less than 600 nm. The weight-average particle size is generally at least nm, preferably at least 50 nm, and advantageously the average size is within the range from 100 to 400 nm. The polymer particles can form agglomerates, referred to as secondary particles, the weight-average size of which is less than 5000 μm, preferably less than 1000 μm, advantageously of between 1 and 80 micrometers and preferably from 2 to 50 micrometers. The agglomerates can break up into discrete particles during formulation and application to a substrate.

According to certain embodiments, the PVDF homopolymer and the VDF copolymers are composed of biobased VDF. The term “biobased” means “derived from biomass”. This makes it possible to improve the ecological footprint of the membrane. Biobased VDF may be characterized by a content of renewable carbon, that is to say of carbon of natural origin originating from a biomaterial or from biomass, of at least 1 at %, as determined by the content of ¹⁴C according to the standard NF EN 16640. The term “renewable carbon” indicates that the carbon is of natural origin and originates from a biomaterial (or from biomass), as indicated below. According to certain embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

Emulsion polymerization enables the production of a latex of particles of approximately 200 nm which, after drying, for example spray drying, results in particles having a volume-mean diameter (Dv50) ranging from 10 to 50 μm.

A PVDF post-synthesis powder is melted by means of a single-screw, twin-screw or counter-rotating extruder, or a Buss co-kneader, or an extruder-dryer, in order to obtain, by means of cooling under water and depending on the type of cutting system, granules in lenticular form or cylindrical form, having a size of a few millimeters.

The granules thus obtained are then ground in a mill of hammer mill, knife mill, air jet mill, jar mill or ball mill type. The grinding can be done at room temperature or with cooling under liquid nitrogen, referred to as cryogenic grinding.

The PVDF polymer has a particle size defined by a Dv50 of less than or equal to 120 μm, preferably of between 30 and 80 micrometers.

The Dv50 referred to here is the volume-median diameter, which corresponds to the value of the particle size which divides the population of particles examined exactly into two. The Dv50 is measured according to the standard ISO 9276-parts 1 to 6. In the present description, a Malvern INSITEC System particle size analyzer is used and the measurement is carried out by the dry route by laser diffraction on the powder.

This powder has a tapped bulk density of greater than 0.4 g/ml, preferably of between 0.5 and 1.2 g/ml, advantageously of between 0.6 and 1.0 g/ml, which defines it as a dense powder.

In order to measure the tapped bulk density, a known amount of PVDF powder is introduced into a precision graduated cylinder. The mass is weighed using a scale with precision to 0.1 g. Said powder is then tapped in a tapping machine of STAV 2003 type, which can cause 220 to 250 jolts per minute. After 2500 taps, the volume Vx is measured. The bulk density (BD) is then calculated as follows:

$$Tapped\_BD = \frac{{M}_{p}}{{V}_{x}}$$

Surprisingly, it was observed that the powder resulting from the ground granules, while having a particle size larger than the post-synthesis powder, makes it possible to obtain higher degrees of grafting and therefore an ion exchange capacity (IEC) of greater than 0.65 mmol/g, higher than for the post-synthesis powder.

### PVDF Material in Powder Form

The material according to the invention consists of a PVDF in irradiated powder form to which at least one vinyl monomer is grafted.

According to one embodiment, said at least one vinyl monomer is chosen from styrene monomers and nitrile monomers, said irradiated and grafted PVDF bearing proton exchange sulfonate groups.

According to one embodiment, the material according to the invention consists of a PVDF in irradiated powder form to which a styrene monomer is grafted, said irradiated and grafted PVDF bearing proton exchange sulfonate groups.

According to one embodiment, the material according to the invention consists of a PVDF in irradiated powder form to which a nitrile monomer is grafted, said irradiated and grafted PVDF bearing proton exchange sulfonate groups.

According to one embodiment, the material according to the invention consists of a PVDF in irradiated powder form to which a styrene monomer and a nitrile monomer are grafted, said irradiated and grafted PVDF bearing proton exchange sulfonate groups.

This material is prepared according to a process which comprises the grafting of an irradiated PVDF with at least one monomer chosen from styrene monomers and nitrile monomers, or with a mixture of styrene and nitrile monomers, followed by a post-treatment of the PVDF powder thus irradiated and grafted, by sulfonation.

Each step of this process is detailed below.

According to one embodiment, the PVDF powder is first exposed to ionizing radiation to introduce active sites into the PVDF polymer chain. The powder is irradiated by an electron beam, gamma ray or X-ray source at a dose of between 25 and 150 kgray and preferably between and 125 kgray. The irradiation is carried out under vacuum, under air or under nitrogen. An irradiated PVDF powder is thus obtained. The irradiated PVDF powder then undergoes a step of grafting with at least one vinyl monomer chosen from styrene monomers and nitrile monomers or with a mixture of styrene and nitrile monomers.

According to one embodiment, said styrene monomer is of alpha-alkylstyrene type, with the alkyl group chosen from: methyl, ethyl, propyl, butyl, pentyl, and hexyl.

According to one embodiment, said styrene monomer is chosen from the group: α-methylstyrene, α-fluorostyrene, α-bromostyrene, α-methoxystyrene, vinyl pentafluorostyrene and α,β,β-trifluorostyrene.

According to one embodiment, said styrene monomer is α-methylstyrene (AMS).

According to one embodiment, said nitrile monomer is chosen from the group: acrylonitrile, 2-methyl-2-butenenitrile, 2-methylene glutaronitrile and methylacrylonitrile.

According to one embodiment, the grafted PVDF powder is passed into a bath at 60° C. containing between 30% and 50% of alpha-methylstyrene, between 30% and 50% of methylene glutaronitrile and between 0 and 40% of isopropanol before being rinsed with isopropanol.

According to one embodiment, the styrene monomer/nitrile monomer molar ratio in the material ranges from 0.7 to 1.3.

According to one embodiment, said nitrile monomer is 2-methylene glutaronitrile (MGN).

Measurements by nuclear magnetic resonance (MRI), via the calculation based on the ratio between the area of a specific peak of the aromatic group and/or of a specific peak of the nitrile group relative to a PVDF reference peak, show a degree of grafting of the powdered PVDF, by weight, of between 10% and 100%, preferably between 15% and 30%.

The irradiated and grafted PVDF powder is then subjected to a post-functionalization reaction with chlorosulfonic acid, followed by hydrolysis in water or an alkaline solution. This enables the cation exchange —SO₃H function to be introduced onto the PVDF. According to one embodiment, the PVDF is grafted with α-methylstyrene and 2-methylene glutaronitrile and is functionalized with chlorosulfonic acid.

According to one embodiment, the sulfonation of the grafted powder is carried out in a dichloromethane solution containing chlorosulfonic acid at room temperature.

The grafted PVDF powder bearing the covalently bonded —SO₃H functions is then rinsed with distilled water until the rinsing water has a neutral pH, before being hydrolysed at 80° C., and then dried in air.

The sulfonated grafted PVDF thus has an ion exchange capacity (IEC) of greater than 0.65 mmol/g, preferably greater than 0.7 mmol/g.

The IEC is measured as follows: a 1 cm×1 cm sample is immersed in a 0.5 M KCl solution overnight with stirring. The hydrogen ions present in the solution, after exchange with K⁺ on the sulfonate groups, are then titrated to pH=7 with a 0.05 M KOH solution. The ion exchange capacity is then calculated according to the equation below:

$$IEC = \frac{n ( {H}^{+} )}{{W}_{dry}} = \frac{c ( KOH ) \times V ( KOH )}{{W}_{K} - [ M ( {K}^{+} ) - M ( {H}^{+} ) ] [ c ( KOH ) \times V ( KOH ) ]}$$

where n(H⁺) is the number of moles of protons, W_{dry} is the weight of the dry membrane in its H⁺ form, c (KOH) is the concentration of KOH, V(KOH) is the volume of the KOH solution added for the titration, W_{K} is the weight of the dried membrane in its K⁺ form, and M(K⁺) and M(H⁺) are the molar masses of K⁺ and H⁺, respectively.

### Polymer Electrolyte Membrane

According to another aspect, the invention relates to a process for producing the proton exchange polymer electrolyte membrane from said irradiated, grafted and functionalized PVDF material in powder form, said process comprising converting the PVDF powder into the form of a film which constitutes the membrane. This step of converting the PVDF powder into film form is carried out by any technique known to those skilled in the art: extrusion-blow molding, flat-film extrusion but also, for example, film production by the solvent route.

According to another aspect, the invention relates to a proton exchange polymer electrolyte membrane, said membrane consisting of a film obtained from said PVDF material.

According to another aspect, the invention relates to a process for producing the proton exchange polymer electrolyte membrane from a mixture of said irradiated, grafted and functionalized PVDF material in powder form and another polymer chosen from: polymethyl methacrylate and copolymers thereof, fluoropolymers, polyurethanes and polyesters. Said mixture comprises from 100% to 50% by weight of said irradiated, grafted and functionalized PVDF in powder form. The process comprises converting the mixture into film form. This step of converting the mixture into film form is carried out by any technique known to those skilled in the art: extrusion-blow molding, flat-film extrusion but also, for example, film production by solvent casting.

According to another aspect, the invention relates to a proton exchange polymer composite membrane, said membrane consisting of a porous support impregnated with said PVDF material by the solvent and/or aqueous route, said porous support being a polymer chosen from: polymethyl methacrylate and copolymers thereof, polyethylene, polypropylene, polytetrafluoroethylene (PTFE), fluoropolymers, polyurethanes, polyesters, poly(vinylidene fluoride) (PVDF), polysulfone (PSU), polyethersulfone (PESU), polyimide (PI), and the family of the polyaryletherketones (PAEK), such as PEEK or PEKK. This porous support can be produced according to techniques known to those skilled in the art such as phase inversion, extrusion followed by sequential stretching, melt-blown or spunbond extrusion, or electrospinning.

Dynamic mechanical analysis (DMA) between −40° C. and 140° C. shows that the membrane does not melt. Its elongation at break, measured at 23° C. under 50% relative humidity at a speed of 20 mm/minute, for a film thickness of 20 μm, is greater than 100%.

In membrane-electrode assemblies (MEAs), this powder can be used as a binder between the catalyst, the other electron-conducting additives and the membrane.

According to another aspect, the invention relates to the applications of the proton exchange polymer electrolyte membrane in the following fields:
fuel cells, for example H₂/air or H₂/O₂ fuel cells or methanol/air fuel cells;
electrolyzers;
lithium batteries, it being possible for said membranes to be part of the composition of the electrolytes.

According to one embodiment, the polymer electrolyte membrane is intended to be inserted into a fuel cell device within an electrode-membrane-electrode assembly.

These membranes are advantageously in the form of thin films, having, for example, a thickness of 10 to 200 micrometers.

To prepare such an assembly, the membrane may be placed between two electrodes. The assembly formed by the membrane arranged between the two electrodes is then pressed at an appropriate temperature in order to obtain a good electrode-membrane adhesion.

The electrode-membrane-electrode assembly is then placed between two plates ensuring electrical conduction and the supply of reactants to the electrodes. These plates are commonly referred to as bipolar plates.

### EXAMPLES

The following examples illustrate the invention without limiting it.

Powder A is a PVDF homopolymer which was in post-synthesis powder form and was then extruded in a co-rotating twin-screw extruder. The lenticular granules obtained were then ground in a cryogenic hammer mill.

Powder B is a PVDF homopolymer in post-synthesis powder form.

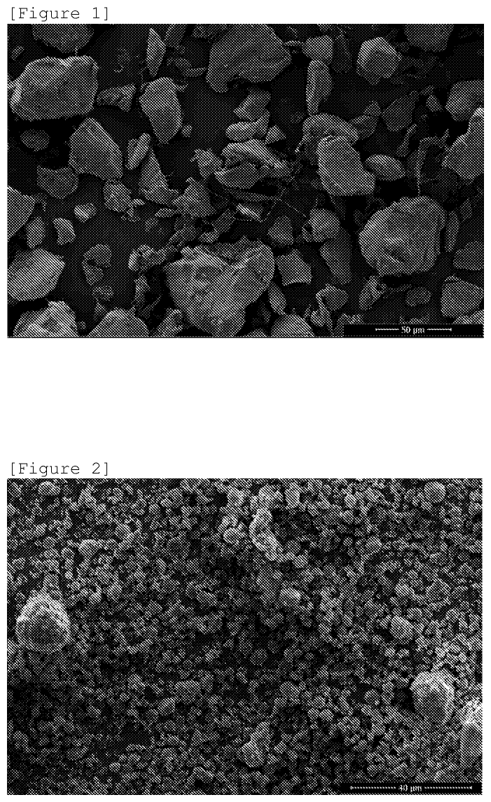

The two powders were analyzed using scanning electron microscopy at 400× magnification: the scanning electron micrograph of powder A is shown in the appended FIG. 1, while the scanning electron micrograph of powder B is shown in the appended FIG. 2.

All the PVDF powders mentioned in the examples were irradiated at 50 kgray under an electron beam, then stored at −30° C. to retain the radicals. The powders were then submerged in a solution of alpha-methylstyrene and methylene glutaronitrile at a 1:1 molar ratio at 60° C. for 6 h.

The degree of grafting is obtained by gravimetry using the following formula:

$$DG = \frac{mass after grafting - initial mass}{mass after grafting}$$

The results obtained are presented in table 1.

TABLE 1

| Examples | A | B |
|---|---|---|
| Nature of the | Ground granules | Post-synthesis |
| powder | | |
| BD (g/ml) | 0.88 | 0.26 |
| D50 | 50 | 10 |
| Type of | PVDF homopolymer | PVDF homopolymer |
| fluorination | | |
| Yield | 0.95 | 0.7 |
| IEC (meq/g) | 0.72 | 0.17 |

Sample A, obtained from ground ground granules, has a tapped bulk density of 0.88 g/ml which makes it possible to most easily separate it from the residual monomers after grafting by means of centrifugation. Conversely, post-synthesis powder B has a bulk density of 0.26 g/ml. The separation of this powder from the residual synthesis monomers after grafting leads to material losses during the washing step. The yield is therefore 0.7, whereas it is greater than 0.9 for powder A.

As was observed in the scanning electron microscopy in FIG. 2, post-synthesis powder B is an aggregate of particles approximately 200 nm in size, which leads to a certain porosity which is reflected in a BD of 0.26 and easier access of oxygen to within the powder. This aggregate also limits physical contact between the monomers and the irradiated powder, referred to as wettability. Due to the presence of oxygen and this low wettability, grafting is impaired, leading to a limiting of the amount of sulfonyl groups added to the PVDF during the post-modification. The IEC value of powder B is therefore only 0.17 mmol/g.

Conversely, powder A resulting from ground granules has a denser and more solid morphology, limiting access of oxygen to the radicals present on the PVDF and thereby promoting grafting. Moreover, since the particles are denser, the wettability of powder A in the monomer mixture is promoted, and it is therefore possible to increase the quantity of sulfonyl groups after post-modification and to thereby improve the ion exchange capacity of the powder, which here is 0.68 mmol/g.

1. A material consisting of an irradiated PVDF in powder form to which at least one vinyl monomer is grafted, said irradiated and grafted PVDF bearing proton exchange sulfonate groups, characterized in that the tapped bulk density of said powder is greater than 0.4 g/ml, preferably between 0.5 and 1.2 g/ml.

2. The material as claimed in claim 1, wherein said vinyl monomer is comprises a styrene monomer.

3. The material as claimed in claim 1, wherein said vinyl monomer is comprises a nitrile monomer.

4. The material of claim 1 as claimed in one of claims 1 to 3, wherein at least one vinyl monomer comprises said PVDF is grafted with a mixture of styrene and nitrile monomers, the styrene monomer/nitrile monomer molar ratio ranging from 0.7 to 1.3.

5. The material of claim 1 as claimed in one of claims 1 to 4, wherein the PVDF is selected from poly(vinylidene fluoride) homopolymers and copolymers of vinylidene difluoride with at least one comonomer selected from the group chosen from the list: vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoro (propyl vinyl ether), perfluoro(methyl vinyl ether), bromotrifluoroethylene, chlorofluoroethylene, chlorotrifluoroethylene, chlorotrifluoropropene, ethylene and mixtures thereof.

6. The material of claim 1 as claimed in one of claims 1 to 5, wherein the PVDF is a vinylidene fluoride homopolymer.

7. The material of claim 1 as claimed in one of claims 1 to 5, wherein the PVDF is a copolymer of vinylidene fluoride and hexafluoropropylene, having a weight percentage of hexafluoropropylene monomer units of from 1% to 35%, preferably from 2% to 23%, preferably from 4% to 20% by weight relative to the weight of the copolymer.

8. The material of claim 1 as claimed in one of claims 1 to 5, wherein the PVDF is a heterogeneous thermoplastic copolymer and comprises two or more co-continuous phases, said co-continuous phases comprising:
a) from 25% to 50% by weight of a first co-continuous phase comprising 90% to 100% by weight of vinylidene fluoride monomer units and 0% to 10% by weight of units of at least one other fluorinated monomer, and
b) from more than 50% by weight to 75% by weight of a second co-continuous phase comprising from 65% to 95% by weight of vinylidene fluoride monomer units and one or more comonomers chosen selected from the group consisting of hexafluoropropylene and perfluoro (vinyl ether), to bring about the phase separation of the second co-continuous phase from the first co-continuous phase.

9. The material of claim 2 as claimed in one of claims 2 and 4 to 8, wherein said styrene monomer is chosen selected from the group: α-methylstyrene, α-fluorostyrene, α-bromostyrene, α-methoxystyrene, vinyl pentafluorostyrene, and α,β,β-trifluorostyrene and combinations thereof.

10. The material of claim 3 as claimed in one of claims 3 to 9, wherein said nitrile monomer is chosen selected from the group: acrylonitrile, 2-methyl-2-butenenitrile, 2-methylene glutaronitrile, and methylacrylonitrile and combinations thereof.

11. The material of claim 1 as claimed in one of claims 1 to 10, wherein said PVDF is grafted with α-methylstyrene and 2-methylene glutaronitrile and is functionalized with chlorosulfonic acid.

12. The material of claim 1 as claimed in one of claims 1 to 11, wherein said powder results from ground PVDF granules having a particle size defined by a Dv50 of less than or equal to 120 μm, preferably of between 30 and 80 micrometers.

13. A process for preparing the material of claim 1 as claimed in one of claims 1 to 12, said process comprising the grafting of an irradiated PVDF powder with at least one vinyl monomer chosen selected from styrene monomers, and nitrile monomers, or with a mixture of styrene and nitrile monomers, followed by a post-treatment of the PVDF powder thus irradiated and grafted, by sulfonation.

14. The process of claim 13 as claimed in claim 13, comprising the following steps:
exposing said PVDF powder to ionizing radiation chosen from electron beams, gamma rays, or X-rays;
exposing the irradiated powder to at least one vinyl monomer chosen selected from styrene monomers, and nitrile monomers, or to a mixture of styrene and nitrile monomer, said styrene monomer being chosen selected from the group: α-methylstyrene, α-fluorostyrene, α-bromostyrene, α-methoxystyrene, vinyl pentafluorostyrene, and α,β,β-trifluorostyrene and combinations thereof, and wherein said nitrile monomer being chosen selected from the group: acrylonitrile, 2-methyl-2-butenenitrile, 2-methylene glutaronitrile, and methylacrylonitrile and combinations thereof;
subjecting the grafted PVDF powder to a post-functionalization reaction with chlorosulfonic acid, followed by hydrolysis in water or an alkaline solution.

15. A process for producing a proton exchange polymer electrolyte membrane from the PVDF material of claim 1 as claimed in any one of claims 1 to 12, said process comprising converting the PVDF powder into film form.

16. A process for producing a proton exchange polymer electrolyte membrane from a mixture of comprising the PVDF material of claim 1 as claimed in any one of claims 1 to 12 and another polymer chosen selected from: polymethyl methacrylate and copolymers thereof, fluoropolymers, polyurethanes, and polyesters, and combinations thereof; said process comprising converting said mixture into film form.

17. A proton exchange polymer electrolyte membrane, said membrane consisting of a film obtained from the PVDF material of claim 1 as claimed in any one of claims 1 to 12.

18. A proton exchange polymer composite membrane, said membrane consisting of a porous support impregnated with the PVDF material of claim 1 as claimed in any one of claims 1 to 12 by the solvent and/or aqueous route, said porous support being a polymer chosen selected from: polymethyl methacrylate and copolymers thereof, polyethylene, polypropylene, polytetrafluoroethylene (PTFE), fluoropolymers, polyurethanes, polyesters, poly(vinylidene fluoride) (PVDF), polysulfone (PSU), polyethersulfone (PESU), polyimide (PI), and the family of the polyaryletherketones (PAEK), such as PEEK or PEKK and combinations thereof.

19. The membrane of claim 17 as claimed in one of claims 17 and 18, having an ion exchange capacity (IEC) of greater than 0.65 mmol/g, preferably of greater than 0.7 mmol/g, as measured by titration with a 0.05 M KOH solution.

20. A fuel cell comprising the membrane of claim 17 a membrane as defined in one of claims 17 to 19.
